(19) United States
(12) Patent Application Publication
(10) Pub. No.: US 2018/0082249 A1
(43) Pub. Date: Mar. 22, 2018

(54) Autonomous Vehicle Content Identification System and Associated Methods

(71) Applicant: Wal-Mart Stores, Inc., Bentonville, AR (US)

(72) Inventors: Donald R. High, Noel, MO (US); David Winkle, Bella Vista, AR (US); Matthew Allen Jones, Bentonville, AR (US); Nicholaus Adam Jones, Fayetteville, AR (US); Robert James Taylor, Rogers, AR (US); Todd Davenport Mattingly, Bentonville, AR (US)

(21) Appl. No.: 15/672,840

(22) Filed: Aug. 9, 2017

Related U.S. Application Data
(60) Provisional application No. 62/396,609, filed on Sep. 19, 2016.

(51) Int. Cl. G06Q 10/08; G06Q 10/06

(52) U.S. Cl. CPC G06Q 10/0833; G06Q 10/0631

(57) ABSTRACT

An example vehicle content identification system and associated methods are described. The example vehicle content identification system includes one or more sensors, a processing device equipped with a processor, and a communication interface. The one or more sensors are configured to detect characteristics of vehicles. The communication interface is configured to enable communication between the one or more sensors and the processing device. The processing device can be configured to execute instructions to obtain a first set of characteristics of a first vehicle detected by the one or more sensors. The processing device can be configured to execute instructions to identify contents of the first vehicle based on the first set of characteristics of the first vehicle.

### CROSS-REFERENCE TO RELATED APPLICATIONS

This application claims the benefit of co-pending, commonly assigned U.S. Provisional Patent Application No. 62/396,609, which was filed on Sep. 19, 2016. The entire content of the foregoing provisional patent application is incorporated herein by reference.

### BACKGROUND

Various vehicles (e.g., trucks) can be used to deliver of objects (e.g., freight or packages) to various locations. Each vehicle can transport a large number of different objects at one time, and can be scheduled to make deliveries at several different locations in a single run. Determining the location of each vehicle, the objects within each vehicle at any given time, the objects scheduled to be delivered by each vehicle, whether the objects scheduled for delivery were actually delivered to the proper location, and whether maintenance of the vehicle is necessary, can be difficult to accomplish.

### SUMMARY

Exemplary embodiments of the present disclosure provide a vehicle content identification system that autonomously identifies contents of each vehicle within a predetermined geographic area without manually checking each vehicle or observing the contents of the each vehicle. In particular, the vehicle content identification system includes a plurality of sensors configured to detect one or more characteristics of each vehicle. Based on the detected characteristics of each vehicle, the vehicle content identification system identifies the contents of each vehicle. Further, based on the detected characteristics of each vehicle, the vehicle content identification system can route each vehicle to the proper loading/unloading dock and/or maintenance dock.

In accordance with embodiments of the present disclosure, an exemplary vehicle content identification system is provided. The vehicle content identification system includes one or more sensors, a processing device, and a communication interface. The one or more sensors can be configured to detect characteristics of vehicles. The processing device can be equipped with a processor. The communication interface can be configured to enable communication between the one or more sensors and the processing device. The processing device can be configured to execute instructions to obtain a first set of characteristics of a first vehicle detected by the one or more sensors. The processing device can be configured to execute instructions to identify contents of the first vehicle based on the first set of characteristics of the first vehicle.

In some embodiments, the one or more sensors include a camera, and the first set of characteristics of the first vehicle can be license plate information detected by the camera. In some embodiments, the one or more sensors include a camera, and the first set of characteristics of the first vehicle can be whether a loading door of the first vehicle is in an open position or a closed position. In some embodiments, the one or more sensors include a scale, and the first set of characteristics of the first vehicle can be a pre-delivery weight of the first vehicle detected by the scale. In some embodiments, the first set of characteristics of the first vehicle can be a post-delivery weight of the first vehicle detected by the scale.

The processing device can be configured to execute instructions to receive as input the pre-delivery weight of the first vehicle, the post-delivery weight of the first vehicle, and weight of contents delivered by the first vehicle between detection of the pre-delivery weight and the post-delivery weight, and determine discrepancies between the weight of the contents delivered by the first vehicle, the pre-delivery weight, and the post-delivery weight. In some embodiments, the one or more sensors include a scale, and the first set of characteristics of the first vehicle can be a gross weight of the first vehicle as compared to an order weight of the contents of the first vehicle. In some embodiments, the scale can include a piezoelectric pad.

In some embodiments, the first set of characteristics of the first vehicle can be an identity of the first vehicle. In some embodiments, the first set of characteristics of the first vehicle can be a time period spent at a delivery point. In some embodiments, the processing device can be configured to execute instructions to route the first vehicle to an appropriate delivery dock based on the identified contents of the first vehicle. In some embodiments, the processing device can be configured to execute instructions to route the first vehicle to a maintenance area based on the first set of characteristics of the first vehicle detected by the one or more sensors.

In accordance with embodiments of the present disclosure, a non-transitory computer-readable medium storing instructions for managing vehicles that are executable by a processing device is provided. Execution of the instructions by the processing device can cause the processing device to detect, via one or more sensors, a first vehicle entering a predetermined geographic area. Execution of the instructions by the processing device can cause the processing device to obtain a first set of characteristics of the first vehicle detected by the one or more sensors. Execution of the instructions by the processing device can cause the processing device to electronically transmit, via a communication interface, the first set of characteristics of the first vehicle from the one or more sensors to the processing device. Execution of the instructions by the processing device can cause the processing device to identify contents of the first vehicle based on the first set of characteristics of the first vehicle.

In some embodiments, execution of the instructions by the processing device can cause the processing device to obtain license plate information of the first vehicle with the one or more sensors, the one or more sensors being a camera. In some embodiments, execution of the instructions by the processing device can cause the processing device to detect whether a loading door of the first vehicle is in an open position or a closed position. In some embodiments, execution of the instructions by the processing device can cause the processing device to obtain a pre-delivery weight of the first vehicle with the one or more sensors, obtain a post-delivery weight of the first vehicle with the one or more sensors, and determine discrepancies between a weight of the contents delivered by the first vehicle, the pre-delivery weight and the post-delivery weight.

In some embodiments, execution of the instructions by the processing device can cause the processing device to obtain a gross weight of the first vehicle as compared to an order weight of the contents of the first vehicle. In some embodiments, execution of the instructions by the processing device can cause the processing device to route the first vehicle to an appropriate delivery dock based on the identified contents of the first vehicle. In some embodiments, execution of the instructions by the processing device can cause the processing device to route the first vehicle to a maintenance area based on the first set of characteristics of the first vehicle detected by the one or more sensors.

In accordance with embodiments of the present disclosure, an exemplary method of vehicle management is provided. The method includes detecting, via one or more sensors, a first vehicle entering a predetermined geographic area. The method includes obtaining a first set of characteristics of the first vehicle detected by the one or more sensors. The method includes electronically transmitting, via a communication interface, the first set of characteristics of the first vehicle from the one or more sensors to the processing device. The method includes identifying contents of the first vehicle based on the first set of characteristics of the first vehicle.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed vehicle content identification system and associated methods, reference is made to the accompanying figures, wherein:

FIG. 1 is a block diagram of an exemplary vehicle content identification system of the present disclosure;

FIG. 2 is a block diagram of an exemplary vehicle characteristics database of the present disclosure;

FIG. 3 is a block diagram of an exemplary identification engine of the present disclosure;

FIG. 4 is a block diagram of an exemplary routing engine of the present disclosure;

FIG. 5 is a block diagram of a computing device in accordance with exemplary embodiments of the present disclosure;

FIG. 6 is a block diagram of an exemplary vehicle content identification system environment in accordance with embodiments of the present disclosure; and

FIG. 7 is a flowchart illustrating an implementation of an exemplary vehicle content identification system in accordance with embodiments of the present disclosure.

### DETAILED DESCRIPTION

Exemplary embodiments of the present disclosure provide a vehicle content identification system that identifies contents of each vehicle within a predetermined geographic area. In particular, the vehicle content identification system includes a plurality of sensors configured to detect one or more characteristics of each vehicle. Based on the detected characteristics of the vehicle, the vehicle content identification system identifies the contents of the vehicle. Further, based on the detected characteristics of the vehicle, the vehicle content identification system can route the vehicle to the proper loading/unloading dock and/or maintenance dock.

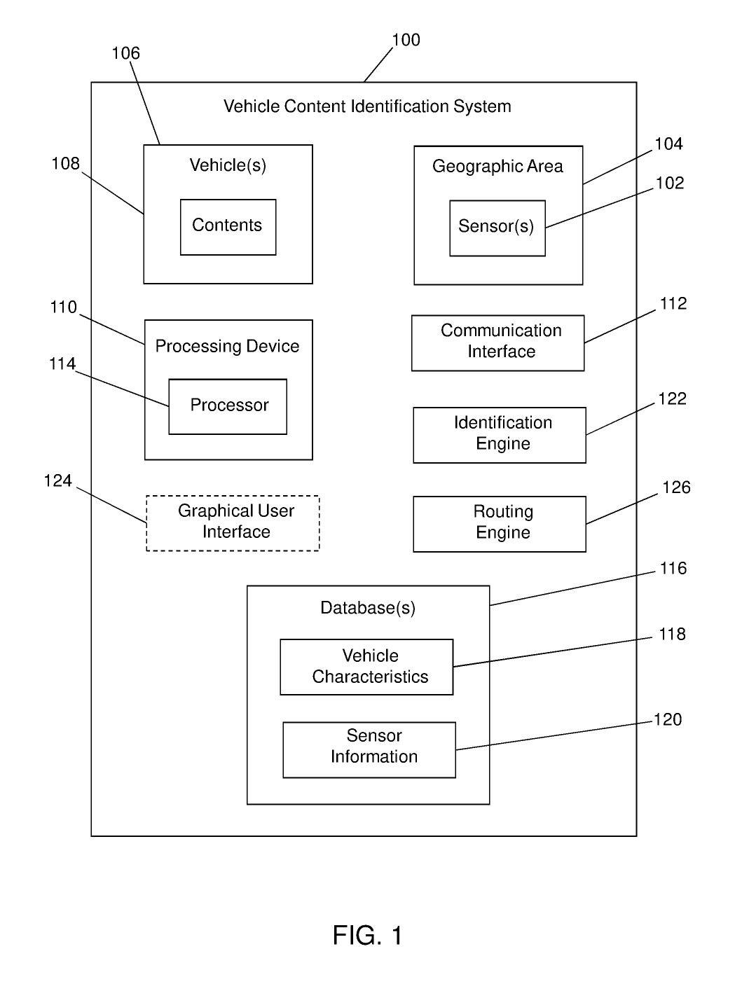

FIG. 1 is a block diagram of an exemplary vehicle content identification system 100 (hereinafter “system 100”) of the present disclosure. The system 100 generally includes a one or more sensors 102 disposed within a predetermined geographic area 104 (e.g., a geographic area of a facility, such as a retail establishment, distribution center, and the like, including the parking lot, maintenance dock and/or area, loading and unloading docks, combinations thereof, or the like). In some embodiments, the sensors 102 can be optical sensors, cameras (e.g., configured for text and/or image recognition), weight scales, combinations thereof, or the like.

In some embodiments, the sensors 102 can include one or more measurement devices, such as an infrared or laser distance measurement device configured to detect and measure the size of the vehicle. In some embodiments, the sensors 102 can include one or more thermal measurement devices configured to detect and measure thermal differences in one or more sections of the vehicle. In some embodiments, the sensors 102 can detect weight differential of the vehicle (e.g., weight measurements at each of the wheels of the vehicle) indicating the load distribution within the vehicle, and the detected load distribution can be compared with an original load plan for a vehicle to determine the difference between the initial, pre-delivery load distribution and the post-delivery load distribution within the vehicle. The system 100 includes one or more vehicles 106 (e.g., delivery trucks) entering and exiting the predetermined geographic area 104.

Each vehicle 106 can include contents 108 therein for delivery to the facility located in the geographic area 104, or can arrive at the geographic area 104 to pick up contents 108 for delivery to a different geographic area. It should be understood that various geographic areas 104 can include the sensors 102 such that as the vehicle 106 travels between geographic areas 104 to pick up contents 108 and/or make deliveries, the sensors 102 can be used to monitor and track each vehicle 106. Each of the sensors 102 can be configured to detect one or more characteristics of each vehicle 106 (e.g., license plate information, a type of vehicle, loading door status, pre-delivery weight, post-delivery weight, content weight, gross weight, order weight, vehicle identity, time of arrival, time of departure, combinations thereof, or the like).

The system 100 includes a processing device 110 and a communication interface 112. The processing device 110 can include a processor 114. The communication interface 112 can be configured to enable electronic communication via wireless and/or wireless means between the sensors 102 and the processing device 110. In particular, the sensors 102 can detect a first set of characteristics of a vehicle 106 entering the geographic area 104, and the communication interface 112 can electronically transmit the detected characteristics to the processing device 110. In some embodiments, the communication interface 112 can electronically transmit the detected characteristics from the sensors 102 to one or more databases 116, and such information can be stored as vehicle characteristics 118. The database 116 can also store sensor information 120, including the location of each sensor 102 and information relating to the type of sensors 102 within the geographic area 104.

The processing device 110 can execute an identification engine 122 that receives as input the vehicle characteristics 118 and identifies the contents of the vehicle 106. In particular, the identification engine 122 determines the contents of the vehicle 106 without physically visualizing the contents within the vehicle 106. As an example, the identification engine 122 can receive multiple detected characteristics, such as the license plate of the vehicle, graphics and/or text on the outside of the vehicle, the pre-delivery weight of the vehicle, and the post-delivery weight of the vehicle to determine the contents of the vehicle 106. As a further example, the license plate information can be used to identify the size of the vehicle and the types of goods generally transported by the vehicle, the graphics and/or text on the outside of the vehicle can be used to identify the operator of the vehicle or the types of products generally transported by the vehicle (e.g., detecting the text “frozen” can imply that the vehicle transports frozen goods), and the weight difference of the vehicle can be correlated with weight of frozen goods to determine which frozen goods were delivered and which are still in the vehicle. The identified contents of the vehicle 106 can be compared to the actual delivery or order information to ensure the proper contents are being delivered or transported. In some embodiments, information relating to such contents can be electronically stored in the database 116. As an example, the sensor 102 can include a camera that captures or detects the license plate information of the vehicle 106, and the identification engine 122 can determine the contents of the vehicle 106 based on the license plate information. As a further example, the sensor 102 can include a camera that detects whether a loading door of the vehicle 106 is in an open position or a closed position to ensure that a vehicle 106 does not accidentally begin driving with the loading door in the open position. As yet a further example, the camera can capture an image of the vehicle 106 and image recognition can be used to determine the type of vehicle (e.g., refrigerated truck, tractor trailer, cargo van, etc.), and the identification engine 122 can determine the contents of the vehicle 106 based on, at least in part, the type of truck detected.

As a further example, the sensor 102 can include a scale (e.g., a piezoelectric pad disposed within the geographic area 104) that measures a pre-delivery weight and a post-delivery weight of the vehicle 106 (e.g., a pre-delivery weight when the vehicle 106 exits the geographic area 104 of one facility and a post-delivery weight when the vehicle 106 exits the geographic area 104 of another facility after delivery has been made, a pre-delivery weight when the vehicle 106 exits the geographic area 104 of a facility and a post-delivery weight when the vehicle 106 returns to the same facility after delivery of at least some of the contents 108 has been made, or the like). The sensors 102 can detect a first set of characteristics of the vehicle 106 at a first time, and can further detect a second set of characteristics of the vehicle 106 at a second time to capture the difference between the characteristics for analysis. For example, the pre-delivery weight can be the first of characteristics detected for the vehicle 106, and the post-delivery weight can be the second set of characteristics detected for the vehicle 106.

In some embodiments, the identification engine 122 can receive as input the pre-delivery weight of the vehicle 106, the post-delivery weight of the vehicle 106, and the weight of contents delivered by the vehicle 106 between detection of the pre-delivery weight and the post-delivery weight. Based on such input information, the identification engine 122 can determine whether discrepancies exist between the weight of the contents delivered by the vehicle 106, the pre-delivery weight and the post-delivery weight, to ensure that the proper contents were delivered by the vehicle 106. If discrepancies exist, the system 100 can issue an alert via a graphical user interface (GUI) 124 to a user of the system 100 such that proper action can be taken (e.g., the delivered contents can be checked with the orders placed to ensure that the proper contents were delivered to the proper locations).

In some embodiments, the sensors 102 can include a scale that detects a gross weight of the vehicle 106 and compares the gross weight of the vehicle 106 to an order weight of the contents 108 of the vehicle 106. Such determination can ensure that the proper contents were loaded onto the vehicle 106 for transport away from the geographic area 104. In some embodiments, the sensors 102 can include optical scanners that detect text and/or images on the outside of the vehicle 106 to determine an identity of the vehicle 106. In some embodiments, the sensors 102 can include a timer that determines the time period spent by the vehicle 106 at a delivery location or point. The system 100 thereby determines discrepancies or errors in delivery or shipping of contents. For example, if the weight of the vehicle 106 does not match the product weight being delivered, the system 100 can issue an alert to a user to request a review of the contents of the vehicle 106. Errors in delivery of wrong items can thereby be determined and corrected to ensure satisfaction of the recipient. Similarly, based on a pre-delivery and post-delivery weight of the vehicle 106, a determination can be made whether all of the contents scheduled for delivery were actually delivered and, if not, the vehicle 106 can be requested to complete the intended deliveries.

In some embodiments, the system 100 can include a routing engine 126. The routing engine 126 can be executed by the processing device 110 to receive as input one or more of the vehicle characteristics 118 and route the vehicle 106 to a maintenance dock or area based on the vehicle characteristics 118. For example, the vehicle characteristic 118 can identify the previous time maintenance was performed on the vehicle 106 and/or the number of miles driven by the vehicle 106 since the previous maintenance event, and can route the vehicle 106 to the maintenance area to perform the periodic maintenance on the vehicle 106. In some embodiments, based on the identification of the contents of the vehicle 106, the routing engine 126 can route the vehicle 106 to the proper loading and/or unloading dock.

For example, if a vehicle 106 is determined to be transporting frozen goods based one or more of the detected characteristics (including a combination of the detected characteristic), the routing engine 126 can route the vehicle 106 to the unloading dock closest to the frozen goods storage section of the facility. As a further example, if a vehicle 106 is determined to be transporting electronics, the routing engine 126 can route the vehicle 106 to the unloading dock closest to the electronics storage section of the facility. The detected characteristics can be used to ensure that the vehicle 106 arriving to the facility for delivery is the proper vehicle 106, and that the vehicle 106 is routed to the proper location within the facility for making the delivery and/or picking up additional items for transport. In some embodiments, if the system 100 determines that the vehicle 106 includes contents that are not time-sensitive and do not require immediate unloading, the routing engine 126 can route the vehicle 106 to a specific parking area until a future time or until an unloading dock is available.

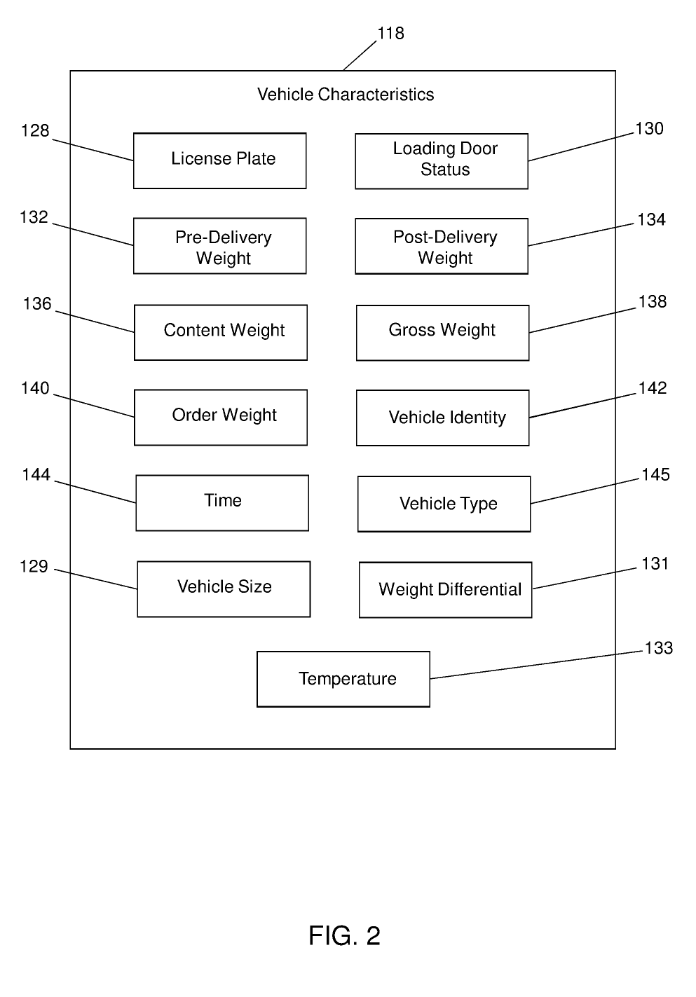

FIG. 2 illustrates examples of the vehicle characteristics 118 of FIG. 1. As a non-limiting example, the vehicle characteristics 118 can include data corresponding to the license plate 128, loading door status 130, pre-delivery weight 132, post-delivery weight 134, content weight 136, gross weight 138, order weight 140, vehicle identity 142, time 144, a vehicle type 145, vehicle size 129, weight differential 131 (e.g., at different corners or wheels of the vehicle), temperature 133 (e.g., thermal differences at one or more sections of the vehicle), combinations thereof, or the like, of the vehicle 106. It should be understood that a variety of other characteristics of the vehicle 106 can be electronically stored within the vehicle characteristics 118 for implementation by the identification engine 122 and/or the routing engine 126.

In some embodiments, the loading door status 130 can include whether the loading door of the vehicle 106 is in the open position or the closed position at various times (e.g., when the vehicle arrives, when the vehicle is at a loading dock, when the vehicle departs). In some embodiments, the vehicle identity 142 can include information related to the source of the vehicle 106, e.g., whether the vehicle 106 is from or owned by the facility or whether the vehicle 106 is owned by a third party or from a facility owned by a third party). In some embodiments, the vehicle identity 142 can include a unique identification number for the vehicle 106. In some embodiments, the time 144 can include the time the vehicle 106 spent at a pick-up location, a drop-off location, between the pick-up location and the drop-off location, or the like. In some embodiments, the vehicle type 145 can include the type of vehicle 106 (e.g., walk-in truck, cargo van, box truck, semi-trailer truck, or the like). In some embodiments, the vehicle size 129 can include the detected or measured size of the vehicle 106. In some embodiments, the weight differential 131 can include the load distribution at each of the wheels of the vehicle 106, the pre-delivery load distribution at each of the wheels of the vehicle 106, and the post-delivery load distribution at each of the wheels of the vehicle 106. In some embodiments, the temperature 133 can include the thermal differences detected at one or more sections of the vehicle 106.

In some embodiments, the sensors 102 can be disposed in specific areas of the geographic area 104 to determine whether the vehicle 106 is passing through the proper locations of the facility. For example, the sensors 102 can be disposed at delivery points, receiving gates, enter and exit locations, grocery pick-up locations, checkpoints, or the like. Thus, the sensors 102 can determine the route a vehicle 106 takes when entering the predetermined geographic area 104, as well as the time spent between each area passed. Such monitoring of the vehicle 106 can provide a security measure for ensuring that the vehicle 106 does not divert from the intended route or linger in areas (e.g., if the vehicle 106 is entering or passing through sensitive areas of the facility).

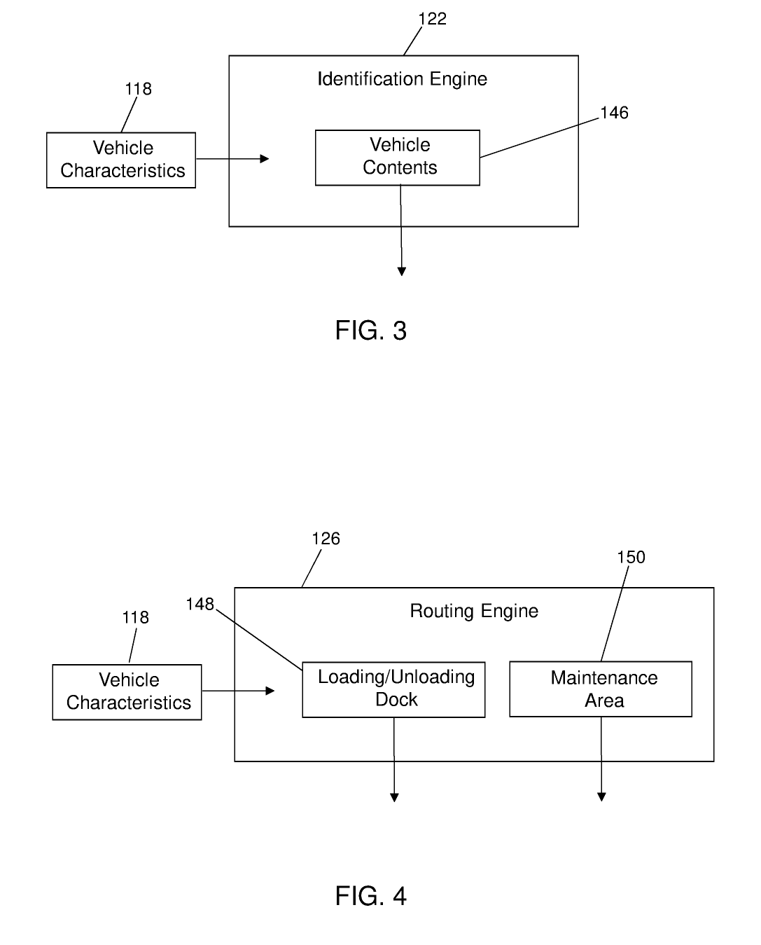

FIG. 3 is a block diagram of an exemplary identification engine 122. As discussed above, the identification engine 122 can be executed by the processing device 110 to receive as input the vehicle characteristics 118. The identification engine 122 can further be executed by the processing device 110 to output an identity of vehicle contents 146. In some embodiments, the vehicle contents 146 can include information on each product within the vehicle 106, such as the product name, product weight, product price, destination delivery, time of delivery, time of pick-up, time at delivery destination, time at pick-up location, combination thereof, or the like.

FIG. 4 is a block diagram of an exemplary routing engine 126. As discussed above, the routing engine 126 can be executed by the processing device 110 to receive as input the vehicle characteristics 118. The routing engine 126 can further be executed by the processing device 110 to output loading/unloading dock 148 information and/or maintenance area 150 information. For example, the loading/unloading dock 148 information can include the loading or unloading dock to which the vehicle 106 should drive to, e.g., a frozen product delivery vehicle 106 should drive to the unloading dock nearest the frozen product storage area of the facility. As a further example, the maintenance area 150 information can include the dock or area at which maintenance will be provided on the vehicle 106. The vehicle 106 can thereby be routed automatically and in real-time to the appropriate area for pick-up, delivery and/or maintenance without necessitating manual input from a routing associate.

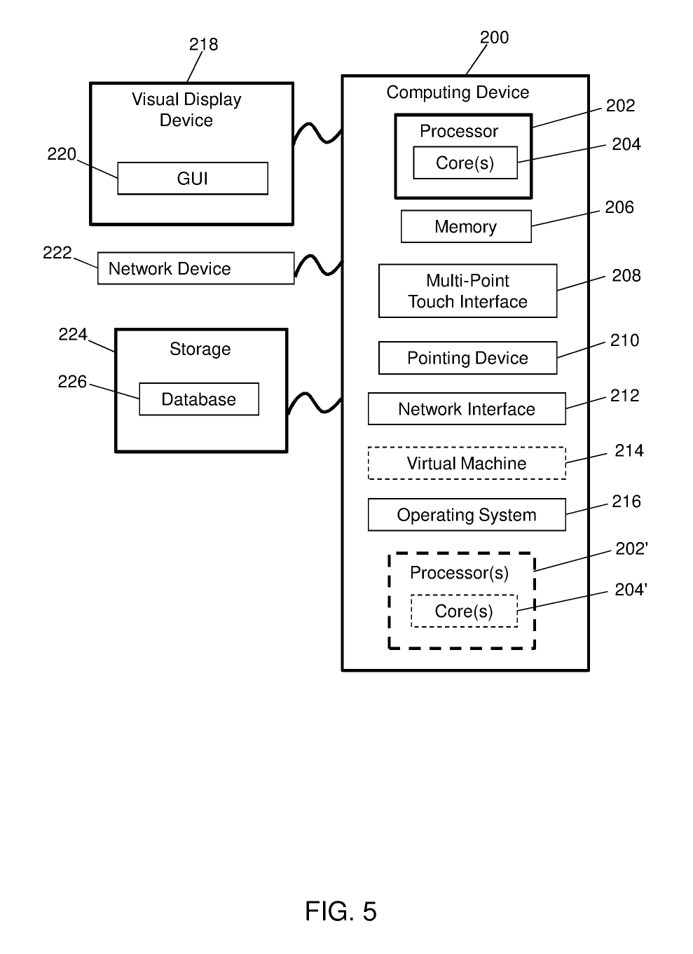

FIG. 5 is a block diagram of a computing device 200 in accordance with exemplary embodiments of the present disclosure. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the present disclosure (e.g., instructions for actuating or controlling the sensors 102, executing the communication interface 112, executing the identification engine 122, executing the routing engine 126, combinations thereof, or the like). The computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device 200 may be shared dynamically. A virtual machine 214 may be provided to handle a process running on multiple processors so that the process appears to be using only one computing resource rather than multiple computing resources. Multiple virtual machines may also be used with one processor.

Memory 206 may include a computer system memory or random access memory, such as DRAM, SRAM, EDO RAM, and the like. Memory 206 may include other types of memory as well, or combinations thereof.

A user may interact with the computing device 200 through a visual display device 218 (e.g., a personal computer, a mobile smart device, or the like), such as a computer monitor, which may display one or more user interfaces 220 (e.g., GUI 124) that may be provided in accordance with exemplary embodiments. The computing device 200 may include other I/O devices for receiving input from a user, for example, a keyboard or any suitable multi-point touch interface 208, a pointing device 210 (e.g., a mouse). The keyboard 208 and the pointing device 210 may be coupled to the visual display device 218. The computing device 200 may include other suitable conventional I/O peripherals.

The computing device 200 may also include one or more storage devices 224, such as a hard-drive, CD-ROM, or other computer readable media, for storing data and computer-readable instructions and/or software that implement exemplary embodiments of the system 100 described herein. Exemplary storage device 224 may also store one or more databases 226 for storing any suitable information required to implement exemplary embodiments. For example, exemplary storage device 224 can store one or more databases 226 for storing information, such as data relating to vehicle characteristics 118, sensor information 120, combinations thereof, or the like, and computer-readable instructions and/or software that implement exemplary embodiments described herein. The databases 226 may be updated by manually or automatically at any suitable time to add, delete, and/or update one or more items in the databases.

The computing device 200 can include a network interface 212 configured to interface via one or more network devices 222 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 212 may include a built-in network adapter, network interface card, PCMCIA network card, card bus network adapter, wireless network adapter, USB network adapter, modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 216 may be run in native mode or emulated mode. In an exemplary embodiment, the operating system 216 may be run on one or more cloud machine instances.

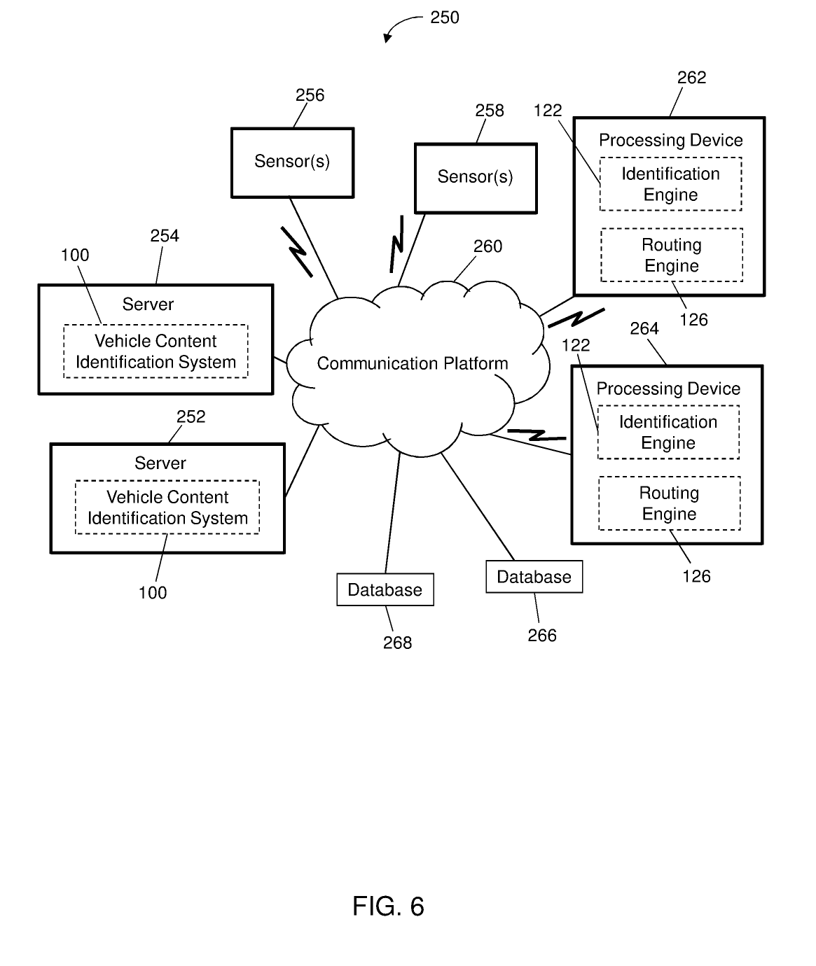

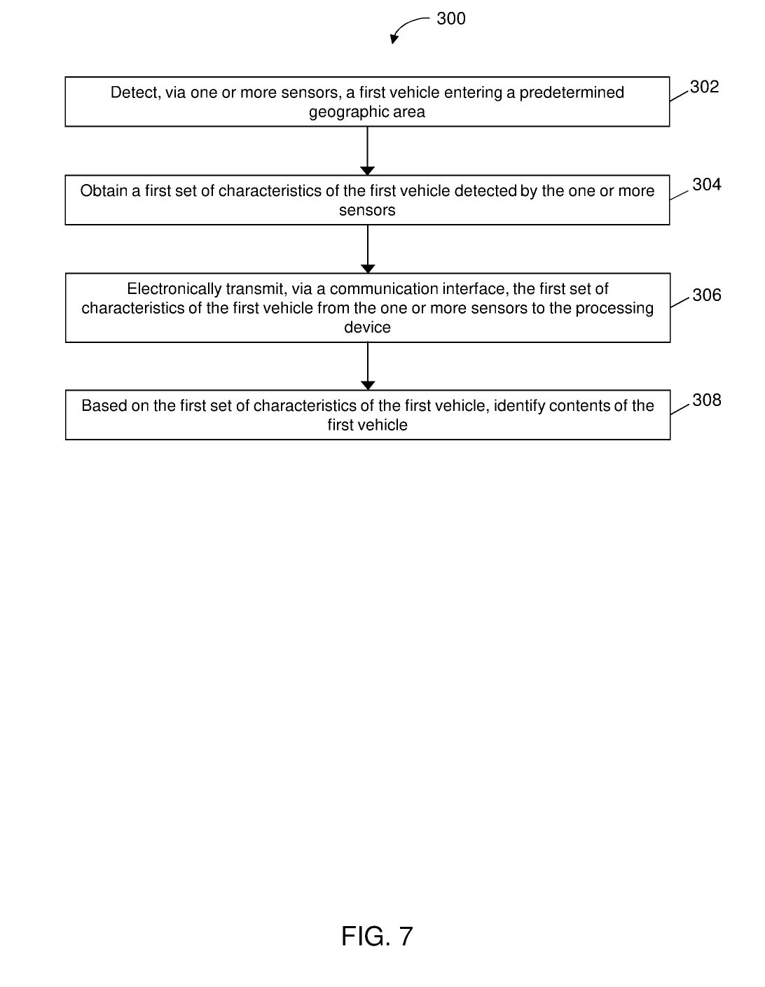

FIG. 6 is a block diagram of an exemplary vehicle content identification system environment 250 in accordance with exemplary embodiments of the present disclosure. The environment 250 can include servers 252, 254 configured to be in communication with sensors 256, 258 (including sensors 102), via a communication platform 260, which can be any network over which information can be transmitted between devices communicatively coupled to the network. For example, the communication platform 260 can be the Internet, Intranet, virtual private network (VPN), wide area network (WAN), local area network (LAN), and the like. In some embodiments, the communication platform 260 can be part of a cloud environment. The environment 250 can include processing devices 262, 264 (e.g., processing devices 110 including one or more portions of the identification engine 122 and/or routing engine 126), which can be in communication with the servers 252, 254, as well as the sensors 256, 258, via the communication platform 260. The environment 250 can include repositories or databases 266, 268, which can be in communication with the servers 252, 254, as well as the sensors 256, 258 and the processing devices 262, 264, via the communications platform 260.

In exemplary embodiments, the servers 252, 254, sensors 256, 258, processing devices 262, 264, and databases 266, 268 can be implemented as computing devices (e.g., computing device 200). Those skilled in the art will recognize that the databases 266, 268 can be incorporated into one or more of the servers 252, 254 such that one or more of the servers 252, 254 can include databases 266, 268. In some embodiments, the database 266 can store the vehicle characteristics 118, and the database 268 can store the sensor information 120. In some embodiments, a single database 266, 268 can store both the vehicle characteristics 118 and the sensor information 120. In some embodiments, embodiments of the servers 252, 254 can be configured to implement one or more portions of the system 100.

FIG. 6 is a flowchart illustrating an exemplary process 300 as implemented by embodiments of the vehicle content identification system 100. To begin, at step 302, the one or more sensors can detect a first vehicle entering a predetermined geographic area in which the sensors are disposed. At step 304, a first set of characteristics of the first vehicle detected by the one or more sensors can be obtained. At step 306, the first set of characteristics of the first vehicle can be electronically transmitted via the communication interface from the one or more sensors to the processing device. At step 308, based on the first set of characteristics of the first vehicle, the contents of the first vehicle can be identified.

Thus, the exemplary vehicle content identification system provides an efficient and effective means for identifying the contents of each vehicle entering and exiting a predetermined geographic area. In particular, by implementing a plurality of sensors configured to detect various characteristics of each vehicle entering and exiting the predetermined geographic area, the contents of each vehicle can be identified without manually checking each vehicle. Further, the detected characteristics can be used to determine whether the proper deliveries have been made to ensure customer satisfaction. Further still, the detected characteristics can be used to efficiently determine the contents of each vehicle to route the vehicle to the proper location within the predetermined geographic area.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A vehicle content identification system, comprising:
one or more sensors to detect characteristics of vehicles;
a processing device equipped with a processor; and
a communication interface configured to enable communication between the one or more sensors and the processing device,
wherein the processing device is configured to execute instructions to:
obtain a first set of characteristics of a first vehicle detected by the one or more sensors; and
based on the first set of characteristics of the first vehicle, identify contents of the first vehicle.

2. The vehicle content identification system of claim 1, wherein the one or more sensors include a camera, and wherein the first set of characteristics of the first vehicle is license plate information detected by the camera.

3. The vehicle content identification system of claim 1, wherein the one or more sensors include a camera, and wherein the first set of characteristics of the first vehicle is whether a loading door of the first vehicle is in an open position or a closed position.

4. The vehicle content identification system of claim 1, wherein the one or more sensors include a scale, and wherein the first set of characteristics of the first vehicle is a pre-delivery weight of the first vehicle detected by the scale.

5. The vehicle content identification system of claim 4, wherein the first set of characteristics of the first vehicle is a post-delivery weight of the first vehicle detected by the scale.

6. The vehicle content identification system of claim 5, wherein the processing device is configured to execute instructions to receive as input the pre-delivery weight of the first vehicle, the post-delivery weight of the first vehicle, and weight of contents delivered by the first vehicle between detection of the pre-delivery weight and the post-delivery weight, and determine discrepancies between the weight of the contents delivered by the first vehicle, the pre-delivery weight, and the post-delivery weight.

7. The vehicle content identification system of claim 4, wherein the one or more sensors include a scale, and wherein the first set of characteristics of the first vehicle is a gross weight of the first vehicle as compared to an order weight of the contents of the first vehicle.

8. The vehicle content identification system of claim 4, wherein the scale comprises a piezoelectric pad.

9. The vehicle content identification system of claim 1, wherein the first set of characteristics of the first vehicle is an identity of the first vehicle.

10. The vehicle content identification system of claim 1, wherein the first set of characteristics of the first vehicle is a time period spent at a delivery point.

11. The vehicle content identification system of claim 1, wherein the processing device is configured to execute instructions to route the first vehicle to an appropriate delivery dock based on the identified contents of the first vehicle.

12. The vehicle content identification system of claim 1, wherein the processing device is configured to execute instructions to route the first vehicle to a maintenance area based on the first set of characteristics of the first vehicle detected by the one or more sensors.

13. A non-transitory computer-readable medium storing instructions for managing vehicles that are executable by a processing device, wherein execution of the instructions by the processing device causes the processing device to:
detect, via one or more sensors, a first vehicle entering a predetermined geographic area;
obtain a first set of characteristics of the first vehicle detected by the one or more sensors;
electronically transmit, via a communication interface, the first set of characteristics of the first vehicle from the one or more sensors to the processing device; and
based on the first set of characteristics of the first vehicle, identify contents of the first vehicle.

14. The medium of claim 13, wherein execution of the instructions by the processing device causes the processing device to obtain license plate information of the first vehicle with the one or more sensors, the one or more sensors being a camera.

15. The medium of claim 13, wherein execution of the instructions by the processing device causes the processing device to detect whether a loading door of the first vehicle is in an open position or a closed position.

16. The medium of claim 13, wherein execution of the instructions by the processing device causes the processing device to obtain a pre-delivery weight of the first vehicle with the one or more sensors, obtain a post-delivery weight of the first vehicle with the one or more sensors, and determine discrepancies between a weight of the contents delivered by the first vehicle, the pre-delivery weight and the post-delivery weight.

17. The medium of claim 13, wherein execution of the instructions by the processing device causes the processing device to obtain a gross weight of the first vehicle as compared to an order weight of the contents of the first vehicle.

18. The medium of claim 13, wherein execution of the instructions by the processing device causes the processing device to route the first vehicle to an appropriate delivery dock based on the identified contents of the first vehicle.

19. The medium of claim 13, wherein execution of the instructions by the processing device causes the processing device to route the first vehicle to a maintenance area based on the first set of characteristics of the first vehicle detected by the one or more sensors.

20. A method of vehicle management, comprising:
detecting, via one or more sensors, a first vehicle entering a predetermined geographic area;
obtaining a first set of characteristics of the first vehicle detected by the one or more sensors;
electronically transmitting, via a communication interface, the first set of characteristics of the first vehicle from the one or more sensors to the processing device; and
based on the first set of characteristics of the first vehicle, identifying contents of the first vehicle.
